(19) United States
(12) Patent Application Publication
(10) Pub. No.: US 2014/0049998 A1
(43) Pub. Date: Feb. 20, 2014

(54) DC to AC Power Converter

(71) Applicants: Leo F. Casey, San Francisco, CA (US); Boris Semenov, Southborough, MA (US); Bogdan S. Borowy, San Diego, CA (US); Joseph T. Mossoba, Cambridge, MA (US)

(72) Inventors: Leo F. Casey, San Francisco, CA (US); Boris Semenov, Southborough, MA (US); Bogdan S. Borowy, San Diego, CA (US); Joseph T. Mossoba, Cambridge, MA (US)

(21) Appl. No.: 13/968,831

(22) Filed: Aug. 16, 2013

Related U.S. Application Data
(60) Provisional application No. 61/683,920, filed on Aug. 16, 2012.

(51) Int. Cl. H02M 7/5395

(52) U.S. Cl. CPC H02M 7/5395
USPC 363/97

(57) ABSTRACT

A direct current to alternating current converter method and apparatus is disclosed that may comprise a direct current (DC) input source; an alternating current (AC) output inverter circuit, having an input connected across the DC input source; a partial power DC-DC boosting circuit intermediate to the DC input source and the DC input of the inverter stage, configured to increase the input voltage of the DC input source whenever the input voltage falls below a minimum required to synthesize an output waveform of a selected shape and a partial power DC-DC boosting circuit intermediate to the DC input source and the DC input of the inverter stage, configured to increase the input voltage of the DC input source during higher amplitude portions of inverter circuit output voltage waveform.

### RELATED APPLICATIONS

This application claims the benefit of and priority to U.S. Provisional Application No. 61/683,920, filed on Aug. 16, 2012, which is incorporated herein by reference in its entirety.

### FIELD

The embodiments disclosed herein relate to power converters, in particular direct current (DC) to alternating current (AC) power converters for use, e.g., with photovoltaic (“PV”) energy collection systems.

### BACKGROUND

Weaknesses exist in forms of voltage conversion, e.g., for use with photovoltaic systems for converting the DC output of strings or modules of photovoltaic (“PV”) cells to AC, e.g., for connection to the external power grid, or even simply for smaller systems installed, e.g., for individual residential or commercial establishment usage. Forms of such systems employing, as an example, multiple stage conversion, even with multi-level switching, can have inefficiencies associated with the additional switching stage(s), e.g., added switch loss, etc.

It is herein proposed to alleviate or eliminate some or all of such inefficiencies by using fractional/partial power processing to address the weaknesses.

### SUMMARY

A direct current (DC) to alternating current (AC) converter is disclosed, which may comprise a direct current (DC) input source; an alternating current (AC) output inverter circuit, having an input connected across the DC input source; a partial power DC-DC boosting circuit intermediate the DC input source and the DC input of the inverter circuit stage, configured to increase the input voltage of the DC input source whenever the input voltage falls below a minimum required to synthesize an output waveform of a desired shape; and the partial power DC-DC boosting circuit intermediate the DC input source and the DC input of the inverter stage, configured to increase the input voltage of the DC input source during lower amplitude portions of inverter circuit output AC voltage waveform. The partial power DC-DC boosting circuit may comprise one of a unipolar input and a bipolar input. The converter may comprise a bypass switch bypassing the partial power DC-DC boosting circuit once voltage boosting is no longer needed. The converter may be implemented by one of a resonant, quasi-resonant or hard switching circuit or a combination thereof. The converter may comprise the alternating current (AC) output inverter circuit comprising a first power semiconductor switch modulated at a selected output alternating current frequency and a second power semiconductor switch modulated at a varying pulse width modulation to achieve varying amplitude of the output voltage within the selected output alternating current frequency. The converter may comprise the partial power DC-DC boosting circuit comprising a variable tapped voltage control circuit. The converter may further comprise the alternating current (AC) output inverter circuit comprising one of direct current (DC) correction or modulation of the alternating current (AC) output.

The direct current to alternating current converter apparatus disclosed may comprise a direct current (DC) input source; an alternating current (AC) output inverter circuit, having an input connected across the DC input source; and a partial power DC-DC boosting circuit intermediate the DC input source and the DC input of the inverter stage, having a transformer alternately connected to a positive and a negative value of the DC input source and at least one secondary winding connected across a boosting capacitor to increase the input voltage of the DC input source whenever the input voltage falls below a minimum required to synthesize an output waveform of a desired shape. The DC input source may comprise an oppositely poled center tapped DC current source connected to one pole of a transformer winding having a core. The partial power DC-DC boosting circuit may comprise the secondary winding inductively coupled to the core.

A method of converting direct current to alternating current includes: providing a direct current (DC) input from a direct current (DC) input source; providing an alternating current (AC) output from an alternating current (AC) inverter circuit, having an input connected across the DC input source; and increasing the input voltage of the DC input source whenever the input voltage falls below a minimum required to synthesize an output waveform of a desired shape using a partial power DC-DC boosting circuit intermediate the DC input source and the DC input of the inverter stage to increase the input voltage of the DC input source during lower amplitude portions of inverter circuit output voltage waveform.

### BRIEF DESCRIPTION OF THE DRAWING

The presently disclosed embodiments will be further explained with reference to the attached drawings, wherein reference to like structures are by like numerals throughout the several views. The drawings shown are largely schematic and not necessarily to scale, with emphasis instead generally being placed upon illustrating the principles of the presently disclosed embodiments.

FIG. 1 shows a prior art input voltage boost power converter circuit feeding a second stage dc/ac inverter, providing a single phase AC output;

FIG. 2 shows a prior art inverter circuit having a four-switch inverter output stage;

FIG. 3 shows a prior art two-switch inverter bridge with a full wave rectified AC output and an unfolder to connect the output to an external power grid;

FIG. 4 shows a partial power boost circuit according to aspects of embodiments of the disclosed and claimed subject matter with a six-switch three-phase AC output inverter;

FIG. 5 illustrates graphically the operation of a circuit such as shown in FIG. 4 and FIG. 6 to reduce the input voltage during certain portions of the production of an AC output, according to aspects of embodiments of the disclosed and claimed subject matter; and

FIG. 6 shows a partial power boost circuit as shown in FIG. 4 with a single phase AC output inverter stage, according to aspects of embodiments of the disclosed and claimed subject matter.

While the above-identified drawings set forth presently-disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiment(s).

### DETAILED DESCRIPTION

It is herein proposed to alleviate or eliminate some or all of the inefficiencies with prior art systems, particularly for use in converting PV output DC voltage to AC. According to aspects of embodiments of the disclosed and claimed subject matter fractional/partial power processing may be utilized to address the weaknesses in the prior art.

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one/an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various aspects, features, or possible requirements are described which may be aspects, features or possible requirements for an embodiment(s) but not for another embodiment(s).

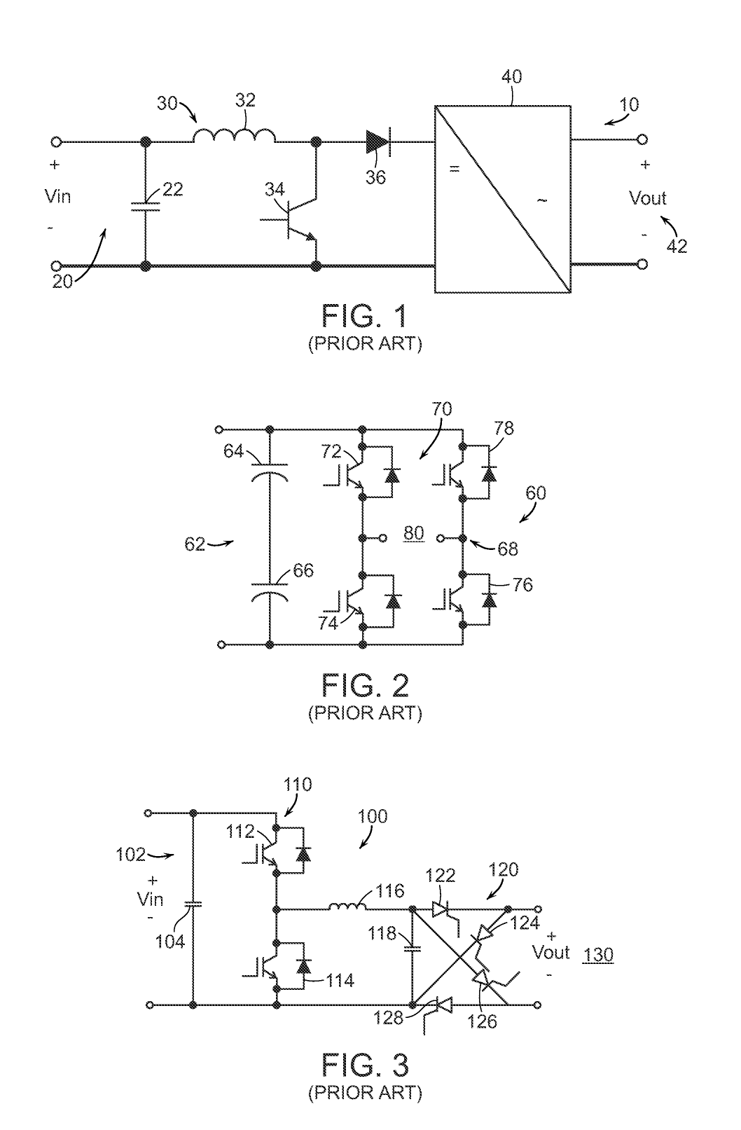

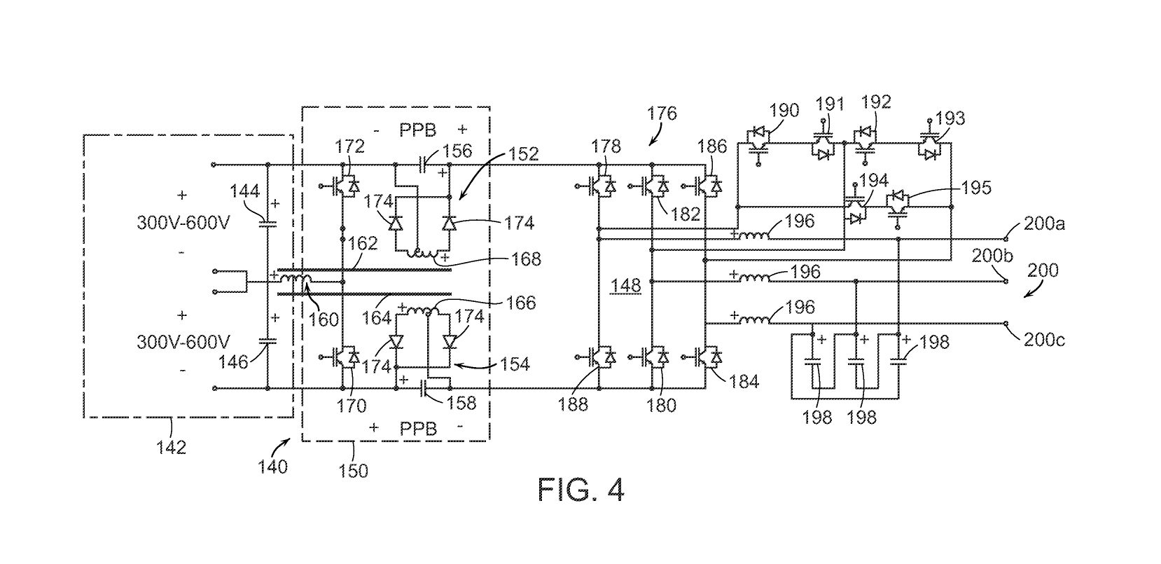

A topology of a conventional two stage, transformerless, photovoltaic power converter/inverter 10 with a floating, unipolar or bipolar input 20 is shown by way of illustration in FIG. 1. This is representative of existing art. For the US, the output 42 could be a single phase 240Vᵣₘₛ at the output 42 of the inverter 40, as is further illustrated by way of example and discussed in more detail below with respect to outputs 80, 120 and 250 in regard to FIG. 2, FIG. 3 and FIG. 6, or could have a three phase output (which would most likely be 480Vᵣₘₛ in the US and 400Vᵣₘₛ in Europe), as illustrated by way of example and discussed in further detail below with respect to output 200 in FIG. 4. The input, e.g., as illustrated at 20 and 102, respectively in FIG. 1 and FIG. 3 could be a single floating “UL” (<600V in compliance with the National Electric Code, NFPA70) input, or could, as illustrated at 62, 142 and 212 in FIG. 2, FIG. 4 and FIG. 6, respectively, have multiple bipolar UL inputs, or could even have a single high voltage input (>600V).

An inverter such as, by way of example, 20, 150 and 210 in FIG. 1, FIG. 4 and FIG. 6, respectively, may have, as shown by way of example in FIG. 1, multiple stages. In the prior art inverter of FIG. 1 there may be a boost stage 30, which may include a high power semiconductor switch 34, such as a high power insulated gate MOSFET or an insulated gate bipolar transistor (“IGBT”) connected in parallel with the input capacitor 22 and intermediate a series connection of an inductor 32 and diode 36. In operation, as an example, energy stored in the inductor 32 is used to boost or add to the input voltage according to the duty cycle of the switch 34 and “boosts” the input voltage to the inverter stage 40.

Such a prior art circuit as illustrated in FIG. 1 may serve, e.g., when necessary, at the lowest input voltages, to boost the voltage to ensure, e.g., that the output voltage can be created with acceptable harmonics. As an example, a 240V_{RMS} grid voltage (so-called split phase in the US) has a peak voltage of 339.4V. If one adds on the NEMA and ANSI required 6-10% tolerance range, a peak connection voltage of 373.4V results (at 10%). Further adding a margin for the output filter of another 10% leads to a required minimum DC output voltage for the output stage of 410.74V. This voltage is higher than the 300-325 V that is typically the bottom of the UL range for photovoltaic (“PV”) modules that require an approximate 2:1 voltage range and operate in the US NEC (NFPA70) 600V environment.

An output stage 40, 70, 120, 148 and 240 shown by way of example in FIG. 1, FIG. 2, FIG. 3, FIG. 4 and FIG. 6, can be formed as a single phase output 42, 80, 130 or 250 from either a four-switch H-bridge 68 or 240, as shown by way of example in FIG. 2 and FIG. 6, or a two switch phase leg 120 formed by a half-bridge 110, as illustrated by way of example in FIG. 3, followed by a single phase unfolder 120 (essentially a single phase version of a matrix switch network, which may also incorporate a rectifier (not shown) function as well). A single phase output connection in such transformerless designs may form the line and neutral phase connections connected to the normal power grid, then the negative DC bus of the inverter may form a floating ground with respect to the earth or neutral. The potential on the negative DC bus with respect to earth can contain high frequency harmonics due to the switching operation of the bridges.

By way of further example, there are several modulation patterns that are possible for the 4-switch bridges illustrated as examples in FIG. 2 and FIG. 6. Such a bridge 68 as part of the inverter section 70 of the prior art circuit 60 of FIG. 2, as illustrated by way of example, may comprise a DC input 62 formed by input capacitors 64 and 66, and a four switch bridge 68 in the inverter section 70, i.e., without any boost or buck to the input DC. The bridge 68 may comprise switch pairs 72, 74 and 78, 80, the pairs being connected in series together and in parallel to each other across the DC input 62. The switches 72, 74 and 76, 78 may have formed at their respective interconnection nodes the terminals of an AC output 80. Furthermore, the split capacitor arrangement (64 and 66) in FIG. 2 may be realized as a single capacitor.

One possibility is synchronized operation of the two phase legs, but with complementary modulation, which could produce a single phased half wave rectified AC output wave form. Another possibility is to operate one of the phase legs at line frequency, and the other phase leg at the modulation switching frequency, in which event the switch pair operated at line frequency acts as a commutator and the pair operating at the higher frequency pulse width modulated switching frequency forms the rough sinusoidal output wave form that can then be smoothed in a low pass filter such as the LC filter 242 illustrated by way of example in FIG. 6. FIG. 4 illustrates by way of example similar LC filters 196, 198 for each of the phases of the three phase output terminals 200a, 200b and 200c of the output 200 from the power converter of FIG. 4.

In this second approach, as illustrated by way of example in FIG. 2, “neutral” may alternatively be connected to the positive or negative rail through the line frequency half bridges. For the single phase application, illustrated by way of example in FIG. 1, FIG. 2, FIG. 3, and FIG. 6 the inverter section could be single ended (essentially unipolar), and as illustrated by way of example in FIG. 3 may have an unfolder 120 (i.e., a single phase version of a matrix switch), or be double ended, as shown by way of example in FIG. 2. FIG. 3 illustrates by way of example a prior art circuit 100 with a single bridge 110 made up of switches 112 and 114 connected across the DC input capacitor 104 of the DC input 102 and an output low pass filter made up of inductor 116 and capacitor 118 to feed a full-wave rectified AC output to the unfolder 120. For each full-wave rectified sinusoidal output current pulse from 116, the unfolder 120 activates alternating pairs of thyristors (122 and 128, or, 124 and 126), to generate alternating current to inject into the grid. The unfolder 120 is made up of a matrix of controlled turn-on devices such as thyristors, or fully controlled devices such as transistors or gate-turn-off thyristors. Any of these controlled devices may be optically controlled by the controller (not shown) and can function to provide a sinusoidal AC, e.g., for connection to an external power grid.

If the output is instead to be a three phase system, e.g., 480Vᵣₘₛ in the US, then the typical output stage can be a six switch bridge 148 (or equivalently three phase legs), as illustrated by way of example in FIG. 4. Such a system might have a peak line-line voltage of 678V, and again with a 10% margin factored in one gets a 746.7V peak, and then 5-10% (typically use 10%) margin for the output filter reaches 784-821.4 V peak line-line. These can be the values for a transformer isolated system where the AC waveforms can contain some common mode voltage, such as with standard over modulation techniques. Of course, with a transformer it is possible to use another, higher or lower, DC and AC voltage, but a standard output such as 480V is compatible with industry standard transformers. If the 10% filter margin cannot be maintained the result is a degradation in the harmonic content. If the output section is transformerless, then the DC link voltage needs to be slightly higher as each phase needs to output the correct line-neutral voltage, again with the two 10% margins included, which requires 2*474.22, or 948.44 V_{dc}.

Turning now to FIG. 4 there is shown a topology for a power converter 140, illustrated by way of example, which can, e.g., as part of the first stage DC-DC power conversion, implement a partial power boost, and thus implement a fractional power converter concept for a DC voltage boosting (amplifying) stage 150, according to aspects of the disclosed and claimed subject matter of the present application. As illustrated by way of example in FIG. 4 the input power for a fractional input stage 150 is taken in parallel from two 300V-600V DC sources, such as a pair of PV module strings (not shown) connected in parallel across respective input capacitors 144, 146, and then applied in series, in order to, in this case, increase the voltage, at least during part of the output line cycle time, e.g., 60 Hz.

The voltage boosting can be on one side of the input, or can be on both sides as shown in FIG. 4. An advantage of adding the boost voltage to the input during part of the cycle on both sides of the input is to, e.g., maintain voltage balance with respect to ground for the bipolar inputs 144, 146, thus allowing for, e.g., full output voltage range while maintaining a hard ground on the center point of the inputs 144, 146 as required by NEC Art. 690.7. Similarly the energy for the voltage addition can come from a single input, or the series combination of bipolar inputs, or from both sides of bipolar inputs. This could be particularly useful if it is important to achieve voltage balance with respect to ground. Because the fractional power circuit 150 modifies the effective voltage and current of the input, it is conceivable that if the tapped magnetics stage 150 were cross coupled it can be possible to operate the two sides of the bipolar input with two different maximum power point trackers (“MPPTs”) for greater converter power transfer efficiency.

The center point between the input capacitors 144, 146 is connected to an inductor coil 160 forming the primary winding of a transformer having magnetic cores 162, 164 and oppositely wound transformer coils 166, 168 to the polarity of the core 160. A high power fully controlled semiconductor switch 170, such as an IGBT or a field effect transistor (FET), or any other controlled device is connected to the negative terminal of input capacitor 146 and the opposite terminal of the primary winding 160. A transistor 172 is connected to the positive terminal of the input capacitor 144 and the opposite terminal of the primary winding 160.

A first partial power booster (“PPB”) 152 is connected in parallel with the switch 172 and may comprise a secondary winding 168 inductively coupled to the core 162 of the transformer, having a variable tap output connected to the negative terminal of a secondary input capacitor 156 connected in series with the input capacitor 144 to add/subtract voltage from the value of the input capacitor 144. Each end of the secondary winding 168 is connected through diodes 174, to the negative terminal of the secondary input capacitor 156. A similar partial power booster (“PPB”) 154 is connected across the terminals of a secondary input capacitor 158 to add/subtract to the voltage of the input capacitor 146. The second partial power booster (“PPB”) 154 is formed of a secondary winding 166, having a variable tap output to the negative terminal of a secondary input capacitor 158, and connected through diodes 174 to the positive terminal of the secondary in-put capacitor 158.

In operation, a controller (not shown) for the circuit 140 is programmed to alternatively operate the switches 170 and 172 with each having a respective duty cycle corresponding to a portion of one half of the output AC cycle of 60 Hz (50 Hz for some countries outside the US), and alternately turning the switches 170 and 172 on and off during their respective duty cycles. In this way, current flows in alternating directions through the inductor 160 forming the primary winding of the transformer during the duty cycle of the operation of the switch 170 from the input capacitor 146 and then during the duty cycle of the switch 172, from the input capacitor 144. Thus, assuming that the primary winding 160 and secondary windings 166, 168 are wound to form a 1:1 transformer, the percentage of the added/reduced voltage across the secondary input capacitors 156, 158 will depend on the settings of the variable taps on the secondary windings 166, 168. This defines the addition/reduction in the input voltage supplied from across the respective input capacitors 144, 146, during the periods of time when the switches 170, 172 are actively processing power.

It will be understood that when the switches 170 and 172 are not in operation (closed) under the control of the controller (not shown), then the addition/reduction voltage across the respective secondary input capacitors 156 and 158 goes to zero and the input voltage to the AC conversion output stage 148 of the converter 140 is the full voltage across the respective input capacitors 144 and 146. If the PP circuitry 150 is not operating the diodes 174 can act as a bypass (or a synchronous bypass device can be used).

The output stage 176 can comprise a standard six switch bridge 148 which may comprise, by way of example, switch pairs 178, 188, 182, 180 and 186, 184, each of which may be a power semiconductor with actively controlled turn-on and turn-off capability. In operation, as an example, the switches 178, 182 and 186 can act as commutator switches operating at one half of the output AC duty cycle (phase), i.e., one half of 60 Hz in the US, during the positive half cycle of the AC output, while the corresponding switches 188, 180 and 184 are operated at a high frequency in a pulse width modulated fashion to form a rough (noisy) respective AC phase connected across respective ones of the output terminals 200a, 200b and 200c of the output 200, a three phase AC output 200, after passing through respective low pass filters, which may comprise inductor-capacitor (LC) filters comprising phase current rated inductors 196 and film capacitors 198. Alternately during the negative half cycle the switches 180, 184 and 188 can perform the commutating function while the respective switches 178, 182 and 186 operate in a pulse width modulated high frequency to generate the negative AC half cycles for the output 200.

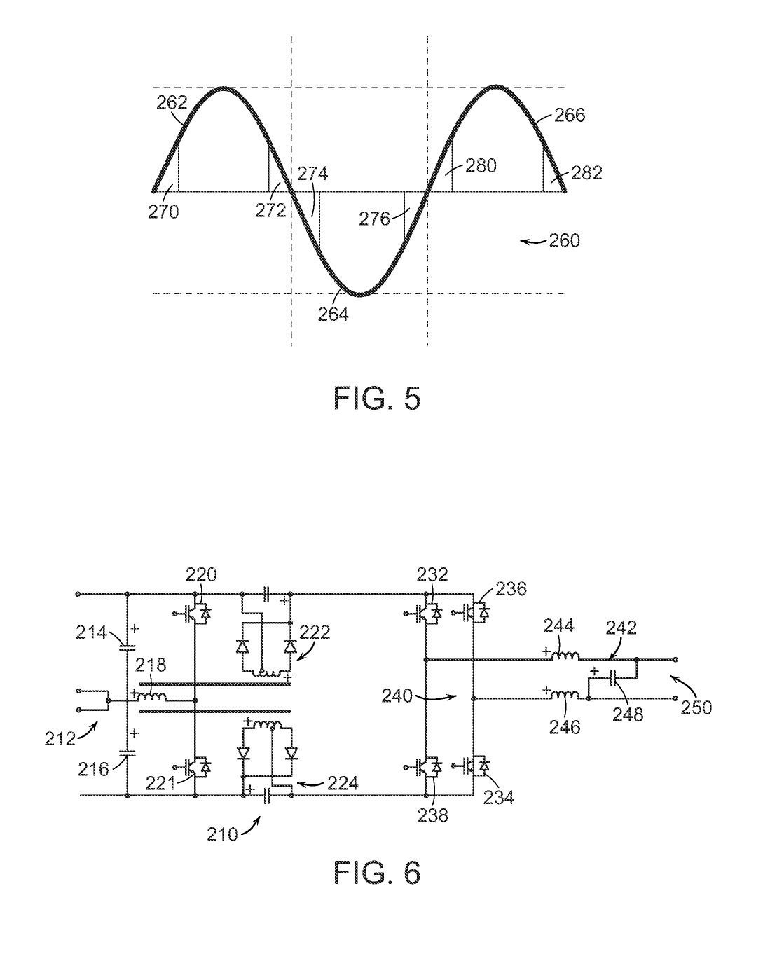

It will be understood that, if desired, the output AC voltage can be half wave (or full wave) rectified in respective phase rectifiers comprising switches 190, 191, 192, 193 and 194, 195. In operation, the controller (not shown) can place the respective partial power boost circuit 152 and the respective secondary input power capacitor 156 in the input stage 142, 150 of the circuit 140 during the periods of time, such as between the periods 270 and 272, and between the periods 280 and 282, as shown by way of example in FIG. 5 when the positive half cycle of the output is at higher amplitude. Conversely for the partial power boost circuit 154 during and secondary input power capacitor 158 this can happen at the times such as between the periods 274 and 276 when the negative half cycle being produced at the output terminal(s) of the circuit 140 is also at a higher amplitude. The partial power boost circuits 152, 154 can then be removed from the input, allowing the full input voltages on the input capacitors 144, 146 to be commutated in forming the output AC 200 during the respective other higher amplitude portions of the AC output.

Turning to FIG. 6 there is shown, by way of example, an essentially identical circuit 210 to the circuit 140 of FIG. 4, with the exception of being arranged to produce a single phase AC output at the output 250. High power semiconductor switches 220, 221 are connected in series with respective input voltage supply capacitors 214, 216 in the input 212 and across the primary winding inductor 218. Partial power boost (“PPB”) circuits 222 and 224 add to the input voltages of the respective input capacitors 214, 216 when placed in the circuit by the controller (not shown), as was the case in the circuit of FIG. 4. The output stage 240 is a standard four switch bridge comprising switch pairs 232, 234 and 236, 238 supplying the output 250 with single phase 60 Hz AC through LC low pass filters 242 made up of inductors 244, 246 and capacitor 248 of the same type and rating as the elements of the output low pass filters in FIG. 4.

It will be understood by those skilled in the art that a direct current to alternating current converter is disclosed, which may comprise a direct current (DC) input source; an alternating current (AC) output inverter circuit, having an input connected across the DC input source; a partial power DC-DC boosting/bucking circuit intermediate the DC input source and the DC input of the inverter stage, configured to increase the input voltage of the DC input source whenever the input voltage falls below a minimum required to synthesize an output waveform of a desired shape; and the partial power DC-DC boosting/bucking circuit intermediate the DC input source and the DC input of the inverter stage, configured to increase the input voltage of the DC input source during lower amplitude portions of inverter circuit output voltage waveform. The partial power DC-DC boosting circuit may comprise one of a unipolar input and a bipolar input. The converter may comprise a bypass switch bypassing the partial power DC-DC boosting circuit once voltage boosting is no longer needed. The converter may be implemented by one of a resonant, quasi-resonant and hard switching or a combination thereof

The converter may comprise the alternating current (AC) output inverter circuit comprising a first power semiconductor switch modulated at a selected output alternating current frequency and a second power semiconductor switch modulated at a varying pulse width modulation to achieve varying amplitude of the output voltage within the selected output alternating current frequency. The converter may comprise the partial power DC-DC converter circuit comprising a partial power DC-DC bucking circuit. The converter may further comprise the alternating current (AC) output inverter circuit comprising one of direct current (DC) correction or modulation of the alternating current (AC) output.

The direct current to alternating current converter apparatus disclosed may comprise a direct current (DC) input source; an alternating current (AC) output inverter circuit, having an input connected across the DC input source; and a partial power DC-DC boosting circuit intermediate the DC input source and the DC input of the inverter stage, having a transformer alternately connected to a positive and a negative value of the DC input source and at least one secondary winding connected across one of a boosting or bucking capacitor to increase the input voltage of the DC input source whenever the input voltage falls below a minimum required to synthesize an output waveform of a desired shape. The DC input source may comprise an oppositely poled center tapped DC current source connected to one pole of a transformer winding having a core. The partial power DC-DC boosting circuit may comprise the secondary winding inductively coupled to the core.

It will be understood that in the foregoing specification, the disclosed subject matter has been described with reference to at least one specific exemplary embodiment thereof It will be evident that various modifications may be made to the disclosed embodiment(s) without departing from the broader spirit and scope of the disclosed and claimed subject matter as set forth in the following claims. As examples, the partial power boost (“PPB”) circuit may comprise a plurality of such circuits, e.g., with different secondary winding tap settings so as to augment the input voltage by differing amounts during the production of the AC output, e.g., for changing the input DC voltage value to the output inverter while the output inverter is operating in progressively higher amplitude regions of the output AC waveform. Further, the single or multiple partial power boost circuits may be utilized with an output inverter producing a half wave rectified AC output, which can then be unfolded to, e.g., provide sinusoidal AC for connection to the external power grid.

A principal advantage of a topology as disclosed by way of example, can be efficient boost conversion due to the partial power processing, which can be enhanced by resonant operation, followed by a regulation stage, resulting in a transformerless system that is lightweight and cost-effective. Once the input voltage is sufficiently high that the voltage boost is not required, then it is possible to utilize a bypass switch around the boost converter, that could be solid state or could be electromechanical, to reduce losses. A fractionally rated, and symmetric, boost converter, as illustrated, can be used with single or multi-phase (typically 3φ) systems. One version shown can have a single phase, non-isolated output, as shown in FIG. 6.

Another possible variation is to introduce transformer isolation, particularly for medium voltage (“MV”) grid interconnection within the utility distribution system. The ability to output a standard 480V can make such a transformer cheaper. The voltage range may be extended and some common mode may be introduced. The partial power converter of the present application could be used to drop voltage as well as boost voltage (if it is bidirectional). This could require some differences in the control of the converter. The converter and associated inverter can be either hard switched or resonant switched. The input source could be bipolar, unipolar with a higher voltage and also center point grounded, as mentioned. A center point grounded input with a neutral point center point in the inverter could be appealing for limiting voltage stresses under fault conditions. If the PV array/source is bipolar, and if it is center point grounded, then it may be necessary to move energy from side to side to balance the voltages. This could be achieved with a “DC transformer”, a term to characterize an approximately fixed conversion ratio dc-dc converter that operates over some load range at very high efficiency, or some cross-coupled magnetics technique(s), such as described above.

The fractional power converter could “cross over” to achieve power balance between the two sides of the center point grounded bipolar source. The single phase or three phase (or n phase) bridge could be fed from the input, and then paralleled with another bridge fed from the output of the fractional power boost. This could take the form of a 6-switch bridge operating from the input and then another 6-switch inverter operating from the boost converter. This configuration can require reverse blocking capability for the switching devices at the lower voltage, otherwise the anti-parallel diodes of the lower voltage bridge may conduct. This is increasingly a possibility with current source inverter (“CSI”) switches. Another variation could be not to have the fractional power boost, but a full boost, with a tapped inductor boost topology, which could also, as noted above, be configured to generate multiple input voltage levels during each AC output cycle for a multi-level second stage.

Isolated power electronics generally allows for less voltage and current stress in fault conditions. A line-line short on the output of a transformer-coupled series resonant converter could be made inherently safe by allowing any fault to detune the resonant network (and increase the impedance), thus limiting the fault current on the primary driving bridge. Hard-switching variations of transformer-coupled converters may also be adequately protected by peak current control (as an example, a flyback converter with MOSFETs and current sensing under sudden short circuit conditions at its output).

In hard switched power circuits the turn-off transition of an IGBT (or any minority carrier device) can entail tail currents and, thus, excessive losses and an effective limitation on switching frequency. This can be addressed, e.g., with quasi or auxiliary resonance to drive the current to zero, or, e.g., paralleling a majority carrier device with the minority carrier and turning off the minority carrier device early, thus, commutating the current to the majority carrier device prior to the turn-off. Similarly it is possible to parallel either devices or modules and operate the majority carrier devices at low current portions of the waveform, and the minority carrier devices at high current portions, this variation including within a single electrical cycle. An intent of this can be to use minority carrier devices when the dominant loss is conduction loss and majority carrier devices when the dominant loss is switching loss.

A direct current to alternating current converter includes: a direct current (DC) input source; an alternating current (AC) output inverter circuit, having an input connected across the DC input source; a partial power DC-DC boosting circuit intermediate the DC input source and the DC input of the inverter stage, configured to increase the input voltage of the DC input source whenever the input voltage falls below a minimum required to synthesize an output waveform of a desired shape; and the partial power DC-DC boosting circuit intermediate the DC input source and the DC input of the inverter stage, configured to increase the input voltage of the DC input source during higher amplitude portions of inverter circuit output voltage waveform.

A direct current to alternating current converter includes: a direct current (DC) input source; an alternating current (AC) output inverter circuit, having an input connected across the DC input source; a partial power DC-DC boosting circuit intermediate the DC input source and the DC input of the inverter stage, having a transformer alternately connected to a positive and a negative value of the DC input source and at least one secondary winding connected across a boosting capacitor to increase the input voltage of the DC input source whenever the input voltage falls below a minimum required to synthesize an output waveform of a desired shape.

A method of converting direct current to alternating current includes: providing a direct current (DC) input from a direct current (DC) input source; providing an alternating current (AC) output from an alternating current (AC) inverter circuit, having an input connected across the DC input source; and increasing the input voltage of the DC input source whenever the input voltage falls below a minimum required to synthesize an output waveform of a desired shape using a partial power DC-DC boosting circuit intermediate the DC input source and the DC input of the inverter stage to increase the input voltage of the DC input source during lower amplitude portions of inverter circuit output voltage waveform.

All such variations and modifications are intended to be included within the scope of the presently disclosed embodiments. The specification and drawings are, accordingly, to be regarded in an illustrative sense rather than a restrictive sense.

All patents, patent applications and published references cited herein are hereby incorporated by reference in their entirety. While the methods, systems and components of the present disclosure have been described in connection with specific embodiments thereof, it will be understood that the embodiments are capable of further modification. Furthermore, this application is intended to cover any variations, uses or adaptations of the methods, systems and components, and of the present disclosure, including such departures from the present disclosure as come within known or customary practice in the art to which the subject matter of the present disclosure pertains and as fall within the scope of the appended claims.

What is claimed is:

1. A direct current to alternating current converter comprising:
a direct current (DC) input source;
an alternating current (AC) output inverter circuit, having an input connected across the DC input source;
a partial power DC-DC boosting circuit intermediate the DC input source and the DC input of the inverter stage, configured to increase the input voltage of the DC input source whenever the input voltage falls below a minimum required to synthesize an output waveform of a desired shape; and
the partial power DC-DC boosting circuit intermediate the DC input source and the DC input of the inverter stage, configured to increase the input voltage of the DC input source during higher amplitude portions of inverter circuit output voltage waveform.

2. The converter of claim 1 further comprising the partial power DC-DC boosting circuit comprising one of a unipolar input and a bipolar input.

3. The converter of claim 1 further comprising a bypass switch bypassing the partial power DC-DC boosting circuit when voltage boosting is no longer needed.

4. The converter of claim 1 further comprising the partial power boosting circuit implemented by a resonant, quasi-resonant or hard switching circuit or a combination thereof.

5. The converter of claim 1 further comprising:
the alternating current (AC) output inverter circuit comprising:
a first power semiconductor switch modulated at a selected output alternating current frequency and a second power semiconductor switch modulated at a varying pulse width modulation to achieve varying amplitude of the output voltage within the selected output alternating current frequency.

6. The converter of claim 1 wherein the partial power DC-DC boosting circuit comprises a variable tap voltage control partial power DC-DC boosting circuit.

7. The converter of claim 1 further comprising the alternating current (AC) output inverter circuit comprising one of direct current (DC) correction or modulation of the alternating current (AC) output.

8. A direct current to alternating current converter comprising:
a direct current (DC) input source;
an alternating current (AC) output inverter circuit, having an input connected across the DC input source;
a partial power DC-DC boosting circuit intermediate the DC input source and the DC input of the inverter stage, having a transformer alternately connected to a positive and a negative value of the DC input source and at least one secondary winding connected across a boosting capacitor to increase the input voltage of the DC input source whenever the input voltage falls below a minimum required to synthesize an output waveform of a desired shape.

9. The converter of claim 8 further comprising:
the DC input source comprising an oppositely poled center tapped DC current source connected to one pole of a transformer winding having a core.

10. The converter of claim 8 further comprising:
the partial power DC-DC boosting circuit comprising the secondary winding inductively coupled to the core.

11. The converter of claim 8 further comprising:
the inverter AC output circuit comprising a first power semiconductor switch modulated at a selected output alternating current frequency and a second power semiconductor switch modulated at a varying pulse width modulation to achieve varying amplitude of the output voltage within the selected output alternating current frequency.

12. The converter of claim 8 further comprising:
the partial power DC-DC converter circuit comprises a partial power DC-DC boosting circuit.

13. The converter of claim 8 further comprising:
the alternating current (AC) output inverter circuit comprising one of direct current (DC) correction or modulation of the alternating current (AC) output.

14. A method of converting direct current to alternating current comprising:
providing a direct current (DC) input from a direct current (DC) input source;
providing an alternating current (AC) output from an alternating current (AC) inverter circuit, having an input connected across the DC input source; and
increasing the input voltage of the DC input source whenever the input voltage falls below a minimum required to synthesize an output waveform of a desired shape using a partial power DC-DC boosting circuit intermediate the DC input source and the DC input of the inverter stage to increase the input voltage of the DC input source during lower amplitude portions of inverter circuit output voltage waveform.

15. The method of claim 14 further comprising the partial power DC-DC boosting circuit comprising one of a unipolar input and a bipolar input.

16. The method of claim 14 further comprising bypassing the partial power DC-DC boosting circuit when voltage boosting is no longer needed using a bypass switch.

17. The method of claim 14 further comprising implementing the partial power boosting circuit using a resonant, quasi-resonant or hard switching circuit or a combination thereof.

18. The method of claim 14 further comprising:
providing the alternating current (AC) inverter circuit output by modulating the DC input to the inverter circuit using a first power semiconductor switch modulated at a selected output alternating current frequency and a second power semiconductor switch modulated at a varying pulse width modulation to achieve varying amplitude of the output alternating current (AC) voltage within the selected output alternating current frequency.

19. The method of claim 14 wherein the partial power DC-DC converter circuit comprises a variable tap voltage control partial power DC-DC bucking circuit.

20. The method of claim 14 further comprising the alternating current (AC) output inverter circuit comprising one of direct current (DC) correction or modulation of the alternating current (AC) output.
